(19) United States
(12) Patent Application Publication
(10) Pub. No.: US 2025/0326601 A1
(43) Pub. Date: Oct. 23, 2025

(54) Plastic Wrap Storage Device

(71) Applicant: Rona Brooks, Linden, VA (US)

(72) Inventor: Rona Brooks, Linden, VA (US)

(21) Appl. No.: 19/077,260

(22) Filed: Mar. 12, 2025

Related U.S. Application Data
(60) Provisional application No. 63/636,130, filed on Apr. 19, 2024.

(51) Int. Cl. B65H 35/00; B26D 1/08; B26F 3/02

(52) U.S. Cl. CPC B65H 35/0086; B26D 1/085; B26F 3/02; B65H 2701/175; B65H 2701/1944

(57) ABSTRACT

A plastic wrap storage device is provided. The device is designed to optimize the organization, storage, protection, and dispensing of plastic wrap rolls, tape, and other packing tools in industrial settings such as factories and warehouses. The device is comprised of a flat bottom surface with a non-slip grip area for stability, and an angled top surface is designed to hold plastic wrap rolls securely, incorporating raised sidewalls and an anti-slip textured coating to prevent displacement. A repositionable divider allows for the accommodation of rolls of varying sizes, while an optional integrated storage compartment provides space for supplementary packing items. In certain embodiments, the device includes a supporting base with lockable wheels for mobility, as well as an internal storage compartment with a hinged door and locking mechanism for organized storage. Some embodiments may also feature a transparent construction for easy visual identification of stored items.

### CROSS-REFERENCE TO RELATED APPLICATION

The present application claims priority to, and the benefit of, U.S. Provisional Application No. 63/636,130, which was filed on Apr. 19, 2024, and is incorporated herein by reference in its entirety.

### FIELD OF THE INVENTION

The present invention relates generally to the field of plastic wrap. More specifically, the present invention relates to a device that optimizes the organization, storage, protection, and dispensing of plastic wrap rolls, tape, and packing tools in industrial settings. Accordingly, the present disclosure makes specific reference thereto. Nonetheless, it is to be appreciated that aspects of the present invention are also equally applicable to other like applications, devices, and methods of manufacture.

### BACKGROUND

In factories, warehouses, and shipping facilities, employees frequently engage in packaging and palletizing tasks that require quick access to numerous items such as plastic wrap, tape, cutting tools, blow torches, stickers, spray bottles, wipes, knives, screwdrivers, and various other tools and supplies. Due to the fast-paced nature of automated and semi-automated production lines, workers often face considerable pressure to maintain efficiency, frequently needing to locate and handle these necessary items rapidly. Typically, these materials and tools are stored haphazardly on tables, carts, or other makeshift storage solutions positioned close to the production lines, resulting in unstable storage arrangements. The vibrations produced by machinery and the rapid movement of products along conveyor belts commonly cause these unsecured items to fall onto the floor, creating significant trip hazards, disruptions in workflow, and potential safety incidents. Additionally, when rolls of plastic wrap or tape drop onto the floor, their edges become damaged, compromising their functionality during pallet wrapping and increasing material waste. Workers regularly discard damaged plastic wrap rolls rather than repairing or reusing them due to the lack of time, knowledge, or adequate repair methods, directly contributing to unnecessary waste and higher operational costs. Furthermore, items such as adhesive labels and stickers frequently become scattered or blown around due to drafts or vibrations, further complicating workers' tasks and exacerbating inefficiencies. These conditions underscore the need for a structured, stable, and comprehensive solution to effectively secure, organize, and dispense packing and wrapping materials and tools within busy factory and warehouse environments.

Therefore, there exists a long-felt need in the art for a plastic wrap storage device that securely organizes essential wrapping materials and tools to prevent accidental displacement and damage. There also exists a long-felt need in the art for plastic wrap storage device that provides safe, ergonomic, and easily accessible storage solutions to minimize trip hazards and improve worker safety. Moreover, there exists a long-felt need in the art for plastic wrap storage device that enables efficient dispensing and organized management of materials and supplies, reducing downtime and waste.

The subject matter disclosed and claimed herein, in one embodiment thereof, comprises a plastic wrap storage device. The device is designed to optimize the organization, storage, protection, and dispensing of plastic wrap rolls, tape, and other packing tools in industrial settings such as factories and warehouses. The device is comprised of a flat bottom surface with a non-slip grip area for stability, and an angled top surface is designed to hold plastic wrap rolls securely, incorporating raised sidewalls and an anti-slip textured coating to prevent displacement. A repositionable divider allows for the accommodation of rolls of varying sizes, while an optional integrated storage compartment provides space for supplementary packing items. In certain embodiments, the device includes a supporting base with lockable wheels for mobility, as well as an internal storage compartment with a hinged door and locking mechanism for organized storage. Some embodiments may also feature a transparent construction for easy visual identification of stored items. Additional enhancements include roll dispensing guides for controlled dispensing and a cutting mechanism integrated into the device for safe and efficient cutting of plastic wrap and tape, improving workflow efficiency and worker safety.

In this manner, the plastic wrap storage device of the present invention accomplishes all the forgoing objectives and provides an organizational solution specifically designed to securely store, protect, and dispense rolls of plastic wrap, tape, and associated packing supplies. This reduces accidental displacement and edge damage to rolls. By also providing designated storage spaces for damaged rolls awaiting repair or recycling, as well as empty spools intended for reuse, the plastic wrap storage device substantially reduces material waste and associated operational costs. Collectively, these features streamline workflow, enhance operational safety, increase efficiency, and effectively address longstanding organizational and safety challenges within industrial and shipping environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plastic wrap storage device. The device is designed for use in factories, warehouses, and shipping environments to securely store, protect, and dispense plastic wrap rolls, tape, and related accessories.

The device comprises a flat bottom surface that includes a grip area made of non-slip materials. The top surface is angled between 1 and 60 degrees to support plastic wrap rolls and may include raised sidewalls to prevent roll displacement. In some embodiments, the top surface features an anti-slip textured coating to reduce shifting or sliding. A repositionable divider is included to accommodate rolls of varying dimensions, secured using adjustable fasteners such as clips, sliding channels, or magnetic attachments. An integrated storage drawer or compartment may be positioned beneath or adjacent to the top surface for storing additional packing items like tape, tools, and safety equipment.

In one embodiment, the device may be mounted on a supporting base with wheels for mobility, with at least one wheel being a locking type. The base can include an internal storage compartment with a hinged, lockable door for organized storage of spare rolls, damaged rolls, or tools. A vertical storage rack may be included to hold rolls upright, preventing damage and waste.

In some embodiments, the body or base may be made from transparent materials for easy visual identification of stored items. The device may also include roll dispensing guides, such as guide rails or friction rollers, to ensure controlled dispensing. Additionally, a cutting mechanism such as serrated or rotary cutters may be integrated to facilitate safe and efficient plastic wrap and tape cutting.

Accordingly, the plastic wrap storage device of the present invention is particularly advantageous as it provides an organizational solution specifically designed to securely store, protect, and dispense rolls of plastic wrap, tape, and associated packing supplies. This reduces accidental displacement and edge damage to rolls. By also providing designated storage spaces for damaged rolls awaiting repair or recycling, as well as empty spools intended for reuse, the plastic wrap storage device substantially reduces material waste and associated operational costs. Collectively, these features streamline workflow, enhance operational safety, increase efficiency, and effectively address longstanding organizational and safety challenges within industrial and shipping environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a plastic wrap storage device of the present invention while empty in accordance with the disclosed architecture;

FIG. 2 illustrates a perspective view of one potential embodiment of a plastic wrap storage device of the present invention while storing plastic wrap rolls in accordance with the disclosed architecture; and

FIG. 3 illustrates a perspective view of one potential embodiment of a plastic wrap storage device of the present invention while empty and having a supporting base in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a plastic wrap storage device that securely organizes essential wrapping materials and tools to prevent accidental displacement and damage. There also exists a long-felt need in the art for plastic wrap storage device that provides safe, ergonomic, and easily accessible storage solutions to minimize trip hazards and improve worker safety. Moreover, there exists a long-felt need in the art for plastic wrap storage device that enables efficient dispensing and organized management of materials and supplies, reducing downtime and waste.

The present invention, in one exemplary embodiment, is comprised of a plastic wrap storage device. The device is intended for use in factories, warehouses, and shipping environments to securely store, protect, and dispense plastic wrap rolls, tape, and related accessories.

The device includes a flat bottom surface with a grip area made of non-slip materials. The top surface is angled between 1 and 60 degrees to support plastic wrap rolls and may incorporate raised sidewalls to prevent roll displacement. In some embodiments, the top surface features an anti-slip textured coating to minimize shifting or sliding. A repositionable divider is included to accommodate rolls of varying dimensions, secured with adjustable fasteners such as clips, sliding channels, or magnetic attachments. An integrated storage drawer or compartment may be located beneath or adjacent to the top surface for storing additional packing items like tape, tools, and safety equipment.

In one embodiment, the device may be mounted on a supporting base with wheels for mobility, with at least one wheel capable of locking. The base may also include an internal storage compartment with a hinged, lockable door for the organized storage of spare rolls, damaged rolls, or tools. A vertical storage rack may be included to hold rolls upright, preventing damage and waste.

In some embodiments, the body or base may be constructed from transparent materials to allow easy visual identification of stored items. The device may also feature roll dispensing guides, such as guide rails or friction rollers, to ensure controlled dispensing. Additionally, an integrated cutting mechanism, such as serrated or rotary cutters, may facilitate the safe and efficient cutting of plastic wrap and tape.

As a result, the plastic wrap storage device offers a structured solution specifically designed to store, protect, and dispense rolls of plastic wrap, tape, and associated packing supplies. This minimizes accidental roll displacement and edge damage. By incorporating designated storage for damaged rolls awaiting repair or recycling, as well as empty spools for reuse, the device significantly reduces material waste and operational costs. These features collectively streamline workflow, enhance safety, improve efficiency, and effectively address organizational and safety challenges in industrial and shipping environments.

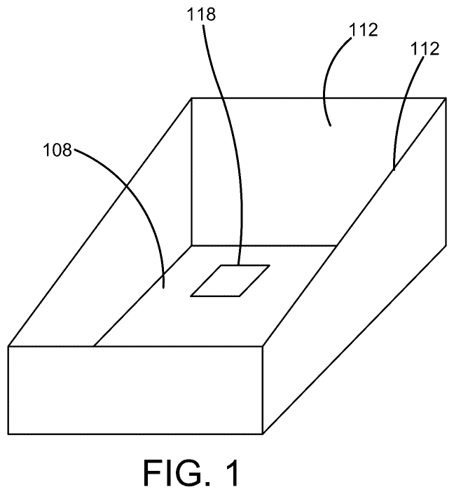

Referring initially to the drawings, FIG. 1 illustrates a perspective view of one potential embodiment of a plastic wrap storage device 100 of the present invention while empty in accordance with the disclosed architecture. The plastic wrap storage device 100 is specifically developed to address the numerous operational challenges commonly encountered in factories, warehouses, and shipping environments where plastic wrap is routinely employed for packaging and palletizing products. Accordingly, the device 100 provides an optimized organizational device designed to effectively secure, store, protect, and dispense rolls of plastic wrap and tape, as well as various other essential tools and accessories utilized within packing and shipping workflows.

The device 100 is comprised of a body 102 preferably constructed from high-impact polyethylene (HDPE) or lightweight aluminum alloy, specifically selected for resilience, case of cleaning, resistance to mechanical impacts, vibrations, corrosion, and chemical exposure. The body 102 is comprised of a flat bottom surface 104. In one embodiment, the bottom surface 104 is further comprised of a grip area 106, fabricated from a textured, non-slip material such as, but not limited to, rubber, elastomeric polymers, silicone-based materials, thermoplastic elastomers (TPE), or textured synthetic composites. The grip area 106 effectively prevents unintended movement or slippage of the body 102 when placed on various floor surfaces or working platforms, significantly improving operational stability and safety.

The body 102 is further comprised of a top surface 108 that is angled between approximately 1 and 60 degrees relative to a horizontal axis of the body 102, specifically configured to securely receive and support plastic wrap rolls 110. The top surface 108 may be further comprised of at least one raised sidewall 112 integrated along one or both longitudinal edges to securely contain plastic wrap rolls 110, significantly reducing the likelihood of accidental displacement or damage caused by floor drops. The raised sidewalls 112 may vary in height depending upon the anticipated roll diameter.

In one embodiment, the top surface 108 is comprised of a rubberized anti-slip textured coating 118 designed explicitly to enhance friction and grip, as seen in FIG. 1. Suitable materials for the textured coating 118 include but are not limited to rubber composites, elastomeric coatings, polyurethane-based textured films, silicone-based gripping surfaces, or sprayed-on polymer coatings with embedded grip particles. This textured coating 118 thereby significantly reduces potential shifting, sliding, or vibration-induced movements of the plastic wrap rolls 110 during operational use, further improving safety and reducing material waste. In one embodiment, the top surface 108 is contoured to receive at least one of the rolls 110.

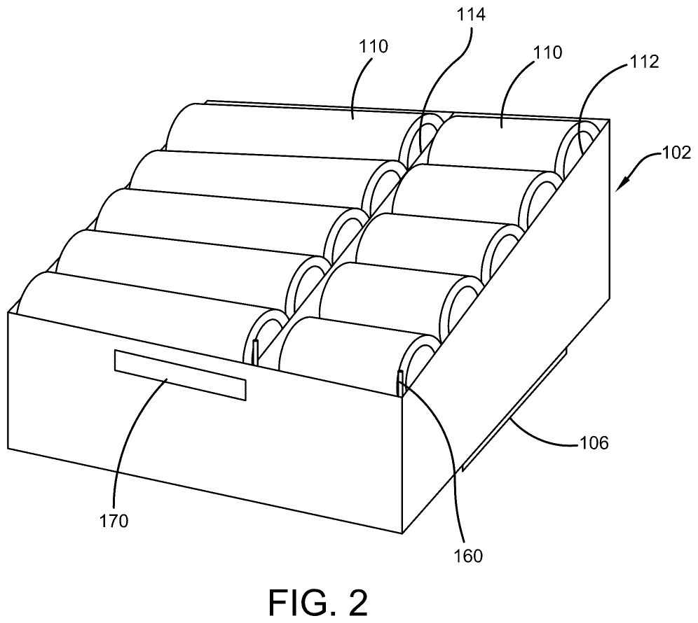

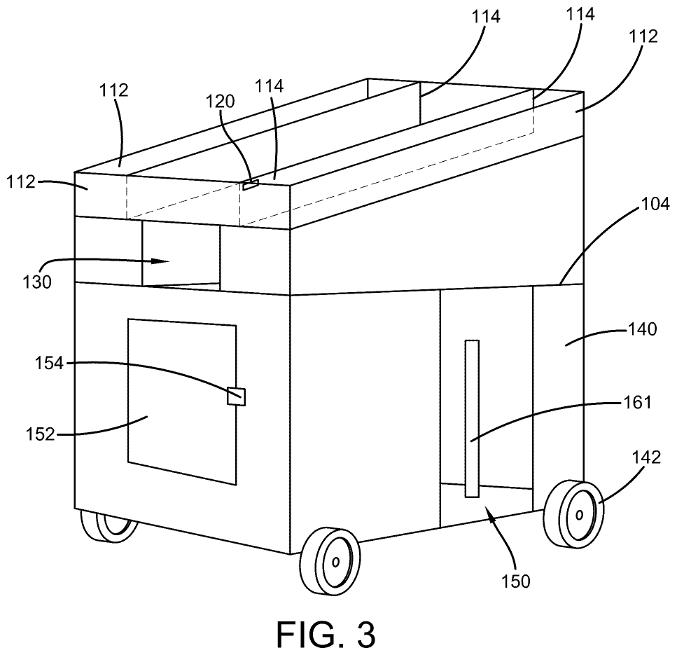

Additionally, in another embodiment, the top surface 108 is comprised of a repositionable divider 114 (as seen in FIG. 2 and FIG. 3) that accommodates plastic wrap rolls 110 of varying widths, diameters, and dimensions. The divider 114 may securely attach to at least one raised sidewall 112 via at least one adjustable or releasable fastener 120, including but not limited to male and female connectors, tongue-and-groove interfaces, sliding channels, integrated clips, spring-loaded clamps, magnetic attachment mechanisms, threaded locking thumbscrews, or hook-and-loop type fasteners. The repositionable divider 114 allows quick tool-free adjustments to facilitate accommodating rolls of different specifications and ensuring rapid transition between packing tasks without downtime or additional tooling requirements.

In another embodiment, the body 102 may be comprised of an integrated storage drawer or compartment 130 positioned beneath or adjacent to the angled top surface 108 (as seen in FIG. 3), specifically configured for safely storing supplementary packing items such as tape, small tools, knives, stickers, safety equipment, or cleaning wipes.

In an alternative embodiment, the body 102 is removably or fixedly attached to at least one supporting base 140, as seen in FIG. 3. The base 140 is further comprised of at least one wheel 142, facilitating the mobility of the device 100 throughout factory floors, warehouses, or shipping departments. The wheel 142 may comprise any suitable wheel type such as polyurethane wheels, solid rubber wheels, pneumatic wheels, thermoplastic wheels, nylon wheels, or heavy-duty industrial-grade casters. In one embodiment, the wheel 142 is a locking wheel capable of locking in both rotational and swivel movements simultaneously.

In the embodiment comprising the supporting base 140, the base 140 may be further comprised of at least one internal storage compartment 150 for the organized storage of spare rolls, damaged rolls awaiting disposal or repair, empty spools awaiting recycling, and additional tools or safety gear. In one specific embodiment, the compartment 150 is further comprised of at least one hinged door 152, which provides easy and convenient access. The hinged door 152 may be securely closed and maintained in the locked position using at least one locking mechanism 154, such as but not limited to magnetic latches, mechanical latches, rotary cam locks, sliding bolts, snap-fit closures, quick-release clasps, friction-fit tabs, or push-button locking systems.

In yet another embodiment, the internal storage compartment 150 is further comprised of at least one vertical storage rack 161 (as seen in FIG. 3) specifically adapted to securely hold and store plastic wrap rolls 110 in an upright orientation. In different embodiments, the vertical storage rack 161 may be in the form of internal dividers, partitions, inserts, padding, or molded channels precisely sized to accommodate standard industrial rolls 110, thereby effectively preventing damage to roll edges, deformation, or subsequent splitting and waste during usage.

In one embodiment, the body 102 and/or the base 140 may be fully or partially transparent and made from transparent materials such as impact-resistant polycarbonate, acrylic, polyethylene terephthalate glycol-modified (PETG), reinforced clear plastics, or other suitable polymeric transparent composites. This facilitates visual identification of items stored within the device 100, thereby streamlining workflow and significantly reducing downtime spent locating required packing materials or tools.

In another embodiment, the device 100 may be comprised of roll dispensing guides 160, such as but not limited to integrated guide rails, friction rollers, cylindrical rollers, low-friction glide strips, or smooth guide edges, thereby promoting controlled and even dispensing of plastic wrap and tape rolls. Additionally, the device 100 may comprise at least one cutting mechanism 170 positioned strategically on the device body 102 or sidewalls 112. The cutting mechanism 170 may include but is not limited to serrated blades, razor blades safely recessed within protective channels, integrated blade sliders, rotary cutters, guillotine-style cutters, or tension-activated cutting bars, designed specifically to safely and efficiently dispense plastic wrap and tape without necessitating separate external cutting tools, thus enhancing worker safety and workflow efficiency.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plastic wrap storage device” and “device” are interchangeable and refer to the plastic wrap storage device 100 of the present invention.

Notwithstanding the forgoing, the plastic wrap storage device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plastic wrap storage device 100 as shown in the FIGS. are for illustrative purposes only, and that many other sizes and shapes of the plastic wrap storage device 100 are well within the scope of the present disclosure. Although the dimensions of the plastic wrap storage device 100 are important design parameters for user convenience, the plastic wrap storage device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plastic wrap storage device comprising:
a body having a flat bottom surface and an angled top surface comprised of a raised sidewall, the angled top surface configured to receive and support a plastic wrap roll; and
a grip area positioned on the bottom surface, wherein the grip area is comprised of a non-slip material.

2. The plastic wrap storage device of claim 1, wherein the angled top surface is an angled between 1 and 60 degrees relative to a horizontal axis of the flat bottom surface.

3. The plastic wrap storage device of claim 1, wherein the grip area is comprised of a texture.

4. The plastic wrap storage device of claim 1, wherein the grip area is comprised of a rubber, an elastomeric polymer, a silicone-based material, a thermoplastic elastomer, or a textured synthetic composite.

5. The plastic wrap storage device of claim 1, wherein the angled top surface is contoured.

6. The plastic wrap storage device of claim 1 further comprised of a roll dispensing guide comprised of an integrated guide rail, a friction roller, a cylindrical roller, a low-friction glide strip, or a smooth guide edge.

7. The plastic wrap storage device of claim 1 further comprised of a cutting mechanism comprised of a serrated blade, a razor blade, an integrated blade slider, a rotary cutter, a guillotine-style cutter, or a tension-activated cutting bar.

8. The plastic wrap storage device of claim 1, wherein the body is comprised of a transparent material.

9. A plastic wrap storage device comprising:
a body having a flat bottom surface and an angled top surface comprised of a raised sidewall, the angled top surface configured to receive and support a plastic wrap roll;
a grip area positioned on the bottom surface, wherein the grip area is comprised of a non-slip material; and
a base comprised of a compartment, the flat bottom surface attached to the base.

10. The plastic wrap storage device of claim 9, wherein the angled top surface is angled between 1 and 60 degrees relative to a horizontal axis of the flat bottom surface.

11. The plastic wrap storage device of claim 9, wherein the angled top surface is contoured.

12. The plastic wrap storage device of claim 9 further comprised of a roll dispensing guide comprised of an integrated guide rail, a friction roller, a cylindrical roller, a low-friction glide strip, or a smooth guide edge.

13. The plastic wrap storage device of claim 9 further comprised of a cutting mechanism comprised of a serrated blade, a razor blade, an integrated blade slider, a rotary cutter, a guillotine-style cutter, or a tension-activated cutting bar.

14. The plastic wrap storage device of claim 9, wherein the body is comprised of a transparent material.

15. The plastic wrap storage device of claim 9, wherein the base is comprised of a transparent material.

16. The plastic wrap storage device of claim 9, wherein the base is comprised of a wheel.

17. The plastic wrap storage device of claim 16, wherein the wheel is comprised of a locking wheel.

18. The plastic wrap storage device of claim 9, wherein the compartment is comprised of a vertical storage rack.

19. A plastic wrap storage device comprising:
a body having a flat bottom surface and an angled top surface comprised of a raised sidewall, the angled top surface configured to receive and support a plastic wrap roll;
a grip area positioned on the bottom surface, wherein the grip area is comprised of a non-slip material; and
a base comprised of a compartment and a door, the flat bottom surface attached to the base.

20. The plastic wrap storage device of claim 19, wherein the door is secured to the base via a locking mechanism.
